(19) United States
(12) Patent Application Publication
(10) Pub. No.: US 2004/0187076 A1
(43) Pub. Date: Sep. 23, 2004

(54) Redirection technique based control method for internet contents providing services and control system for the same

(75) Inventors: Myung Jong Ki, Seoul (KR); Kwon Ho Moon, Gyeonggi-do (KR)

Correspondence Address: OSTROLENK FABER GERB & SOFFEN, 1180 AVENUE OF THE AMERICAS, NEW YORK, NY, 100368403

(73) Assignee: Knowledge Info-Net Service, Inc.

(21) Appl. No.: 10/645,150

(22) Filed: Aug. 21, 2003

(30) Foreign Application Priority Data
Mar. 22, 2003 (KR) 10-2003-0018008

(51) Int. Cl. G06F 15/00

(52) U.S. Cl. 715/513

(57) ABSTRACT

An Internet contents providing service control method using a redirection technique and a control system therefor are provided. A redirection system is disposed between an intermediary's web server and a contents provider's web server. In response to a request from a user computer, the redirection system, instead of the intermediary web server, collects HTML documents provided by the contents provider web server, converts a relative path URL of contents (a variety of form tags, search CGI, images, icons, etc.) contained in the HTML documents into an absolute path URL, and when necessary, further executes additional conversion so that the HTML documents are reconstructed. In addition, the redirection system converts all form tags and hyperlink tags in the HTML documents so that the redirection agent of the redirection system is marked and then transmits to the user computer. By doing so, while the redirection system continuously retains the control right over is the web service of the contents provider web server for the user computer, the contents delivery service is provided.

### BACKGROUND OF THE INVENTION

1. Field of the Invention

The present invention relates to a technology for utilizing a variety of Internet contents that are provided in the form of web services by hypertext transfer protocol (HTTP) servers, and more particularly, to a redirection method, by which contents subscribing institutions can modify the user interface (UI) formats provided by Internet providers, as they want without help from the Internet providers, so as to provide differentiated services, and a system therefor.

2. Description of the Related Art

Generally, digital contents with academic value are digitized by a publishing company or a contents provider (for example, an academic journal publishing institution) holding copyrights of the digital contents, and then are distributed and serviced to a lot of customer institutions (for example, an electronic library of a university) as web services through the Internet. When an institution introducing the contents provides services to users (for example, students or lecturers), till now the institution has to use the user interface (UI) provided by the publishing company or contents provider, without change such that additional service functions appropriate to the characteristic of the customer institution cannot be implemented. In addition, since Internet contents processed and provided generally by contents providers have in many cases the so-called global characteristic that the contents are serviced all around the world, it is actually difficult from the viewpoint of the contents providers to grant a request for any modification needed to suit the service format of a specific customer institution.

FIG. 1 is a conceptual diagram of the pattern of prior art business to business (B2B) Internet contents providing services. According to the prior art Internet contents service pattern, when the web services of Internet contents providers are used under web environments, if information is exchanged between an institution user (A) belonging to a specific institutional subscriber (B) and the web service (C) of a contents provider, the role of the institutional subscriber (B) that is an intermediary is only to simply provide a service route. That is, the user (A) finds what kinds of Internet contents web services are available to the user (A) through the web service (home page) of the institutional subscriber (B), and when necessary, makes the web service (C) linked through the institutional subscriber (B) and uses.

As shown in FIG. 1, if the user (A) accesses the web service (C) of the contents provider through the institutional subscriber (B) (in steps 1 and 2), the role of the institutional subscriber (B) is accomplished and thereafter there is only the relation between the user (A) and the web service (C) of the contents provider. In other words, in the prior art, when the user (A) uses the target web service (C) through the intermediary (B), control is transferred step by step due to the characteristic of the HTTP protocol such that the HTTP server of the contents provider providing the web service takes control and provides services to the user (A), that is, the client, in the relation between the web agent (for example, a browser) and the web server irrespective of the intermediary (B).

In this type of service, the intermediary (B) plays only a gateway role linking its user (A) to the web service (C) of the contents provider only in the first stage of the service. Once the user (A) is connected to the web service (C) of the contents provider, the intermediary (B) cannot take part in and take control of the information service. That is, since in the B2B-type Internet contents service, control of the web service is retained by the contents provider (C), there is a drawback that the institutional subscriber (B), the customer of the contents service, cannot modify or improve the service, including applications and user statistics, to suit its situation. Accordingly, it is a dependent service relationship in which compensation for this drawback has to be performed by the contents provider on the request of the institutional subscriber (B).

This dependent part of web service is not limited to such web services as the B2B or business to consumer (B2C) services but is common to all web services provided in the form of web pages. That is, if a user accesses a web site by using a web browser, the contents serviced to the user is received as the web server processes without change and it is impossible to modify and add additional functions to the contents.

From the viewpoint of the institutional subscriber (B), it is obvious that the institutional subscriber (B) frequently needs to actively take part in the service provided by the contents provider (C) without any help from the contents provider (C) so as to control users and generate log files, and when necessary, to implement more differentiated services, for example, real-time interlocking to other services held by the institutional subscriber (B) by using the services contents provided by the contents provider (C). That is, needed is a method by which the institutional subscriber (B) that is the contents customer such as an electronic library of a university can modify, as it wants, the user interface (UI) format provided by the contents provider (C) without help from the provider so that the customer institution (B) can provided differentiated services.

### SUMMARY OF THE INVENTION

To solve the above problems, the present invention provides an Internet contents service control method based on an HTTP redirection technique, by which when the institutional subscriber (B) provides the contents of the contents provider (C) to the user (B) belonging to the institutional subscriber (B) under the circumstance described above, the institutional subscriber (B) can provide differentiated services as desired with retaining the control right over the contents provider (C) and particularly, can freely add additional functions to the service contents provided by the contents provider (C) to suit the institutional subscriber (B) and provide the contents to the user (A) belonging to the institutional subscriber (B), and a service system for the method.

According to an aspect of the present invention, there is provided a redirection technique based control method for Internet contents providing services in a system wherein a user computer receives digital contents, which are provided by a contents provider web server, through a web page provided by an intermediary web server through the Internet and a redirection system is additionally disposed between the intermediary web server and the contents provider web server. The method performed by the redirection system comprises the steps of: (a) instead the intermediary web server, transmitting a request from the user computer received through the web page, to the contents provider web server, and collecting a hyper-text markup language (HTML) document which the contents provider web server provides in response to the request; (b) reconstructing the HTML document, by converting relative path uniform resource locators (URLs) of the contents such as a variety of form tags, search common gateway interfaces (CGIs), images, icons, etc. contained in the HTML document, into absolute path URLs and when necessary, further performing additional conversion; (c) converting all form tags and hyperlink tags in the HTML document so as to mark the redirection agent of the redirection system in the tags and transmitting to the user computer; and (d) making contents providing services be provided with the redirection system continuously retaining the control right on the web service of the contents provider web server for the user computer.

In the service control method, it is desirable that in the conversion of the hyperlink tags in the step (c), user authentication and session identification (ID) are given to the head part of each hyperlink tag, and if service is provided, a common gateway interface (CGI) program of the redirection agent, having a redirection processing function for all hyperlinks contained in an HTML document provided by the contents provider server, is added, to the head part of each hyperlink tag and original URLs are converted into a parameter form.

Also in the service control method, it is desirable that in the conversion of the form tags in the step (c), the form action part of each form tag is replaced by a form transmission CGI program of the redirection agent, having a redirection processing function for all form transmissions in the HTML document, and the original action URL is added to a form input tag together with service ID registered in the web service profile information of the contents provider web server.

Furthermore, it is desirable that the service control method further comprises performing management, registration, deletion, and modification of control rules, absolute path conversion rules, and limits on use frequency that are registered in order to secure a control right by using a redirection technique.

According to another aspect of the present invention, there is provided a redirection technique based control system for Internet contents providing services in a system wherein a user computer receives digital contents, which are provided by a contents provider web server, through a web page provided by an intermediary web server through the Internet. The control system is disposed between the intermediary web server and the contents provider web sever and includes: a redirection agent unit which operates in the form of a common gateway interface (CGI) program on the intermediary web server, communicates with a redirection server, requests again a document, which is requested by the user computer through the web page of the intermediary web server, to the contents provider server through the redirection server, receives a document of the contents provider server through the redirection server, performs additional conversion of the document, reconstructs the hyper-text markup language (HTML) document for differentiated services, and then transmits the final HTML document to the web browser of the user; and the redirection server which is always in a waiting state in preparation for a call, and if the redirection agent unit makes a call and requests a document of a specific web service, in response to this, accesses a target contents providing web server and requests the document, receives contents provided by the target contents providing web server, performs conversion of the contents, and then transmits the contents to the redirection agent unit.

In the service control system, preferably, the redirection agent unit has a first program which provides first redirection service, a second program which gives user authentication and session ID, and if the service is provided, performs redirection processing for all hyperlinks contained in an HTML document provided by the contents provider server, and a third program which performs redirection processing for all form transmission in the HTML document, as the CGI programs.

In the service control system, it is desirable that the redirection agent unit further includes: a web management tool which registers in a database and manages the web service of a target contents provider web server to be provided as differentiated services through the redirection system; and a specific converter which, based on redirection conversion tags on exceptional events registered in the web management tool, performs conversion for exceptional tags, which are not standardized and an automatic document conversion module is not able to process, so that control right is retained.

In addition, preferably, the redirection agent unit further includes a parser unit which if an HTML document provided by the web service contains a character string satisfying the condition of a parsing tag registered through the web management tool, replaces the character string with the contents written in a parser in order to provide additional application services. Furthermore, the registration item of the web management tool includes at least one or a combination of items, including URL information to access target web services, authentication information when fee-charging contents are provided, and when conversion is needed to provide differentiated services, parsing tags to distinguish a part to be converted in an HTML document, and document transformation parser information, and redirection conversion tags for exceptional events.

Also, in the service control system, it is desirable that the redirection server unit includes at least: a virtual hypertext transfer protocol (HTTP) agent which accesses the target contents providing web server, requests a document in a GET or POST method, collects the document, and stores the collected document in a cache area for each user; an HTML converter which analyzes the contents of the HTML document which is collected and temporarily stored in the cache directory for each user by the virtual HTTP agent, and automatically converts all contents defined by relative URLs among tags such as ‘img’, ‘link’, ‘href’, etc. in the document, into absolute URLs; and a redirection marker which marks the redirection agent unit in the form tag and hyperlink parts so that the redirection system continuously retains the control right over all form tags and hyperlink tags in the HTML document temporarily stored before the document is transmitted to the user by the redirection agent, even though the user clicks on form transmission and hyperlinks.

Particularly, the redirection marker performs conversion of the hyperlink tags by which user authentication and session identification (ID) are given to the head part of each hyperlink tag, and if service is provided, a common gateway interface (CGI) program of the redirection agent, having a redirection processing function for all hyperlinks contained in an HTML document provided by the contents provider server, is added, and original URLs are converted into a parameter form. Furthermore, the redirection marker performs conversion of the form tags by which the form action part of each form tag is replaced by a form transmission CGI program of the redirection agent, having a redirection processing function for all form transmissions in the HTML document, and the original action URL is added to a form input tag together with service ID registered in the web service profile information of the contents provider web server.

Preferably, the redirection server unit further includes a user session management which grants, maintains, and manages a session ID to a user using the redirection system; a cache area management which generates an independent cache directory for each user, and maintains and manages the directories till the user finishes the session of the redirection system; and a target web site session management which maintains and manages session information such as authentication information, cookie, etc. of the web service of the target contents providing web server accessed by the virtual HTTP agent and if there are continuous requests for documents, maintains the connection.

Also, it is desirable that the redirection server unit further includes a listener which is always waiting for a request from the redirection agent, and if there is a request, allocates a spare thread to handle the request; a request analyzer which analyzes the command and parameters requested by the redirection agent, determines the contents to be processed by the server, and calls related modules; and a virtual agent loader which in order to request web service to the web site of the target contents providing web server, writes a script for calling the virtual HTTP agent module and makes a call for the virtual HTTP agent.

### BRIEF DESCRIPTION OF THE DRAWINGS

The above objects and advantages of the present invention will become more apparent by describing in detail preferred embodiments thereof with reference to the attached drawings in which:

FIG. 1 is a conceptual diagram of the pattern of prior art business to business (B2B) Internet contents providing services;

FIG. 2 is a schematic diagram of the structure of a contents delivery service environment employing HTTP redirection system according to the present invention;

FIG. 3 is a schematic diagram of the concept of a contents delivery service based on a redirection technique according to the present invention;

FIG. 4 is a schematic diagram of the structure of a redirection system according to the present invention;

FIG. 5 is a detailed diagram of the structure of redirection server in a redirection system; and

FIG. 6 is a diagram of the structure of a redirection agent unit (UI).

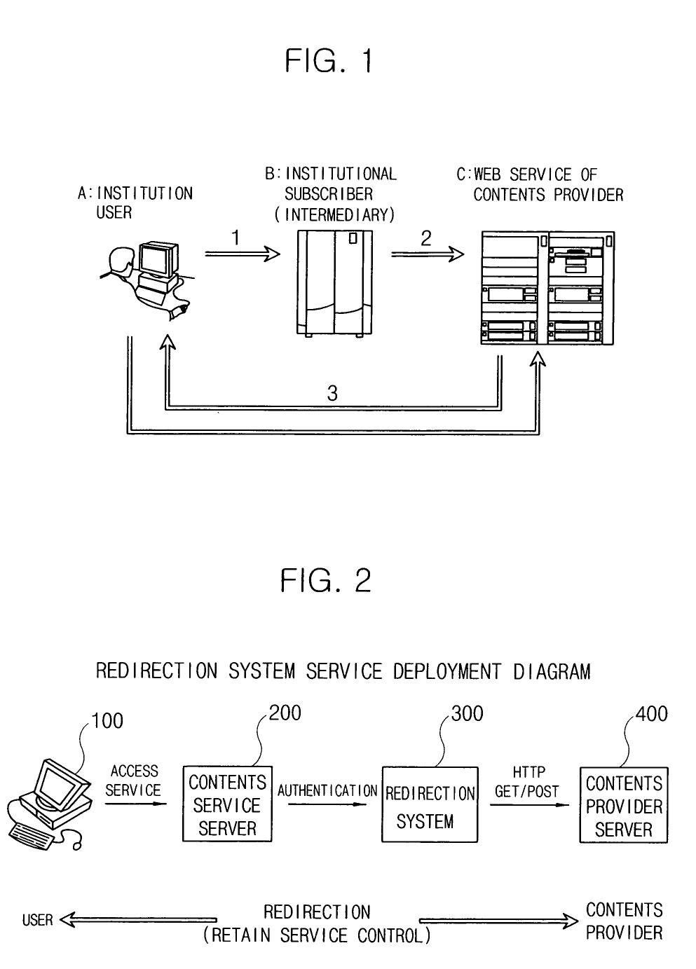

### DESCRIPTION OF THE PREFERRED EMBODIMENTS

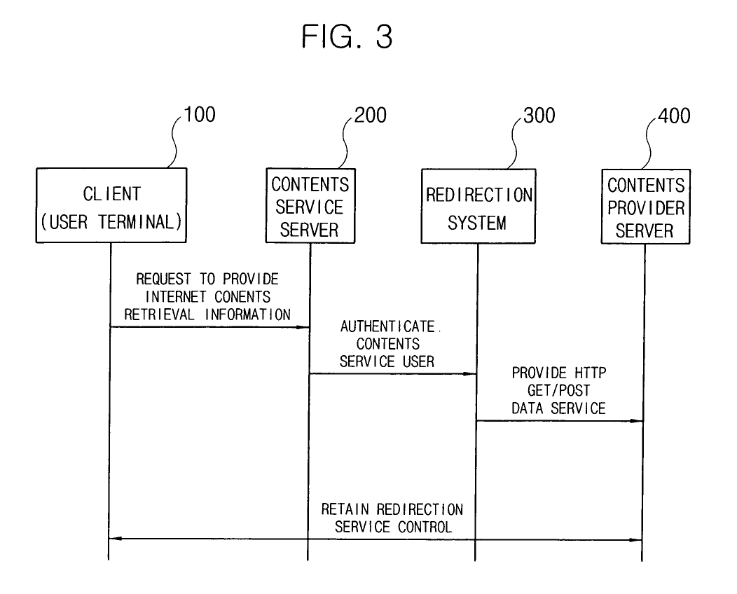

A schematic diagram of the structure of a contents delivery service environment employing HTTP redirection system according to the present invention is shown in FIG. 2, and FIG. 3 shows a schematic diagram of the concept of a contents delivery service based on a redirection technique. The service environment is different from the prior art in that the redirection system is provided between a contents service server 200 providing services, including contents delivery, to a user terminal 100, and a contents provider server 400 providing digital contents to the contents service server 200, and allows the contents service server 200 to secure an independent control right capable of casting off the dependency in relation to the contents provider server 400 for content delivery service.

Roughly speaking, user access, user authentication, data service delivery request and retainment of redirection service control are sequentially performed in the contents providing service using the redirection system.

In order to receive desired digital contents, the user accesses a site managed by the contents service server 200 by using a terminal (client) capable of Internet surfing.

If the user is connected it is desirable for the contents service server 200 to follow, first, a user authentication procedure of the site. That is, when Internet contents are to be accessed, it is confirmed that the user is authenticated for the site and by using representative identification/password (ID/PW) for each site, service access authentication is handled. If the user is not authenticated, the user is connected to an authentication page. By combining representative ID/PW values provided by Internet contents with access URLs, standardized link URLs that can be used in the redirection system according to the present invention are computed and an authentication procedure needed when service is provided is processed. When a link URL is computed, by analyzing an authentication page of the site, the syntax of hyper-text markup language (HTML) form tags is extracted and recorded in a log file based on representative ID/PW information given to ID/PW parameter values and session values. When authentication for fee-charging Internet contents service is performed, representative ID/PW information is processed by reading service profile database (DB) information.

After the user authentication procedure is followed, a redirection technique is applied to process the request of the user 100 for digital contents and the contents of the contents provider server 400 are provided to the user computer 100. The redirection technique minimizes the dependency of a system when the UI of a target site providing digital contents through the Internet is changed. When the target Internet contents using fee and basic information are extracted, a parsing technique is used to extract information. The search UI which is provided through a service link to the user 100 who logs in the contents service server 200 is given the same as the UI of the object site managed by the contents provider server 400. In addition, information on use details (use history) and bills of Internet contents for each user is continuously updated through communications between the redirection system 300 and the user UI. The target web service HTTP server 400a managed by the contents provider provides information requested by the user 100 in the form of Internet contents without any change in the UI.

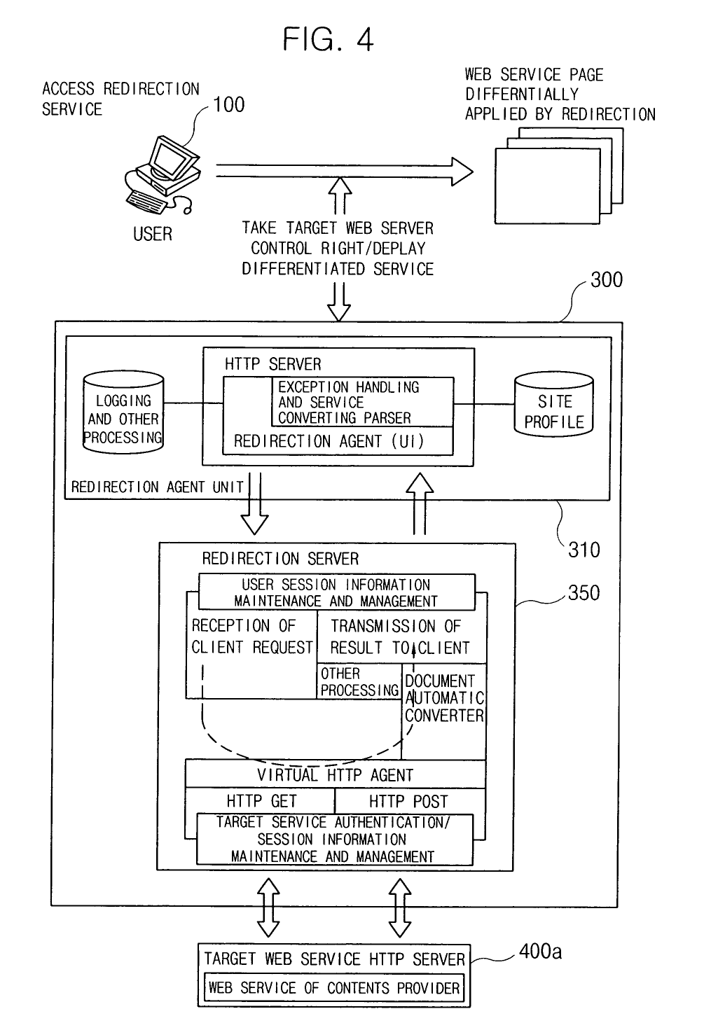

FIG. 4 is a schematic diagram of the structure of a redirection system according to the present invention. As shown, the redirection system comprises a redirection agent unit 310 and a redirection server 350. While operating in the form of a common gateway interface (CGI) program on the web server (HTTP server) and communicating with the redirection server 350, the redirection agent unit (UI) 310 collects target web service documents, adds additional functions for differentiated services to the documents, and transmits the documents to the web browser of the user.

The redirection server 350 is always in a waiting state in preparation for a call. If the redirection agent 310 makes a call and requests a document of a specified web service (redirection target site), a virtual HTTP agent module 358 of the redirection server 350 access the target web server 400a and request the document. The redirection server 350 temporarily stores the contents, which are provided by the target web server 400a in response to this request, first in the cache directory the redirection server 350, and after converting the temporarily stored document by an HTML document automatic converter 360, transfers the document to the redirection agent 310.

The HTML document automatic converter 360 that performs a core function in the redirection server 310 analyzes and processes all tags of the HTML document collected from the target web service 400a. If the path of an image file or style sheet (CSS) file contained in the document is written in the form of a relative URL, the HTML document automatic converter 360 finds this and automatically converts into an absolute path URL. The reason why this conversion is needed is that when the HTML document is provided finally to the user, the web server 200, in which the redirection agent 310 operates, instead of the web server 400a of the target web service retains the control right and transmits the contents. Accordingly, the conversion is to prevent a failure of the HTML document (for example, unable to display images because of failure to find a path of the image) that may occur in this situation. In addition, the HTML document automatic converter module 360 of the redirection server 350 concurrently performs redirect conversion by which all hyperlinks and form transmission tags in the HTML document collected from the target service are marked (redirected) with the redirection agent 310 so that the redirection system 300 can continuously retain the control right.

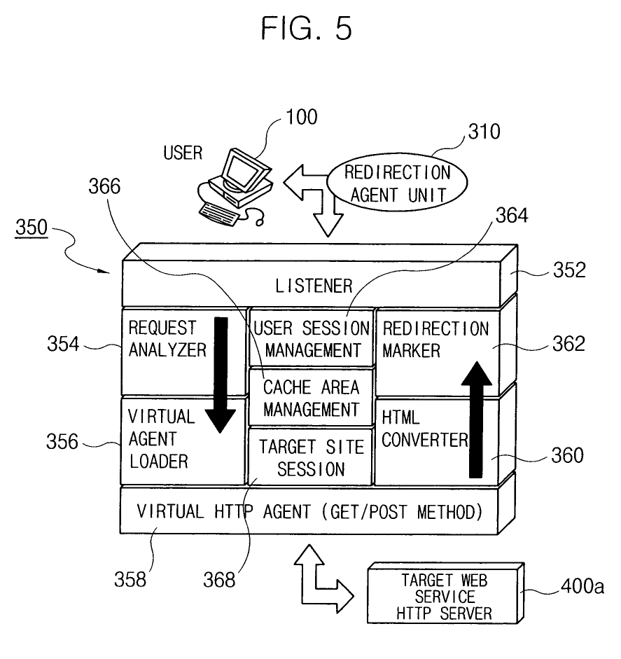

FIG. 5 is a detailed diagram of the structure of the redirection server 300 in the redirection system 300. The redirection server 350 comprises a listener 352, a request analyzer 354, a virtual agent loader 356, a virtual HTTP agent 358, an HTML automatic converter (HTML converter) 360, a redirection marker 362, a user session management 364, a cache are management 366, and a target site session management 368. The specific function of each module will now be explained.

1) listener 352: is always waiting for a request from the client, that is, the redirection agent 310, and if there is a request, allocates a spare thread to handle the request.

2) request analyzer 354: analyzes the command and parameters requested by the client, determines the contents to be processed by the server, and calls related modules.

3) virtual agent loader 356: in order to request web service to the target web site, writes a script for calling the virtual HTTP agent 358 module and makes a call for the virtual HTTP agent 358. The virtual agent loader 356 writes a script according to a GET or POST method by distinguishing document request methods of the target HTTP server 400a and calls a module.

4) virtual HTTP agent 358: accesses the web server 400a of the target web service, requests a document (in the GET or POST method), collects the document, and stores the collected document in a cache area for each user.

5) HTML converter 360: analyzes the contents of the HTML document collected and temporarily stored in the cache directory for each user by the virtual HTTP agent, and automatically converts all contents defined in relative URLs among tags (for example, img, link, href, etc.) in the document, into absolute URLs.

6) redirection marker 362: marks the redirection agent 310 in the form tag and hyperlink parts so that the redirection system continuously retains the control right over all form tags and hyperlink tags in the HTML document temporarily stored before the document is transmitted to the user by the redirection agent 310, even though the user clicks on form transmission and hyperlinks. By doing so, redirection is performed once more such that the form transmission and hyperlinks directed to the target web service HTTP server 400a are redirected to the HTTP server 200a.

7) user session management 364: grants, maintains, and manages a session ID to the user using the redirection system.

8) cache area management 366: generates an independent cache directory for each user, and maintains and manages the directories till the user finishes the session of the redirection system. Documents collected from the target web service are first stored here and after being converted, are transmitted to the user terminal 100 through the redirection agent 310.

9) target site session management 368: maintains and manages session information (authentication information, cookie, etc.) of the target web service accessed by the virtual HTTP agent 358, and if there are continuous requests for documents, maintains the connection.

As described above, the redirection system 300 accesses the HTTP server 400a of the target web service through the redirection server 350, and then instead of the HTTP server 400a, collects and processes documents requested by the user and retransmits the documents to the user. In addition, the redirection marker 362 makes marks to redirect all hyperlinks and form transmission to the redirection agent 310 so that the redirection system can continuously retain the control right over the target web service.

Examples of processes executed by the HTML converter 360 and the redirection marker 362 of the redirection server 350 in order to allow the redirection system 300 to retain the control right of the target web service will now be explained.

First, the HTML converter 360 converts relative URLs into absolute URLs so that the HTML document read from the HTTP server 400a of the target web service can be accurately expressed on the web browser of the user. At this time, the object tags to be converted include image/icon links, each hyperlink, style sheet (CSS) links, etc. An example of tag conversion performed by the HTML converter 360 is shown in the following table 1:

TABLE 1

| Original HTML TAG | Converted HTML TAG |
|---|---|
| <link rel=“stylesheet” type=“text/css” | <link rel=“stylesheet” type=“text/css” |
| href=“MainStyle.css”> | href=“http://ejournals.ebsco.com/MainStyle.css”> |
| <a class=“Header-Menu-Links” | <a class=“Header-Menu-Links” |
| href=“my_SignMeUp.asp”>Sign me up</a> | href=“http://ejournals.ebsco.com/my SignMeUp.as |
| | p”>Sign me up</a> |
| <img src=“images/toolbar-browse.gif” | <img |
| align=“absmiddle” | src=“http://ejournals.ebsco.com/images/toolbar |
| | browse.gif” align=“absmiddle”> |
| <BODY BGPROPERTIES=FIXED | <BODY BGPROPERTIES=FIXED |
| background=“images/bg.jpg”> | background=“http://203.250.229.136/images/bg.jp |
| | g”> |
| <input type=“image” src=“images/SEARCH.gif”> | <input type=“image” |
| | src=“http://203.250.229.136/images/SEARCH.gif”> |

As shown in the above conversion example, by adding http://ejournals.ebsco.com/ or ://203.250.229.136/ to a variety of tags (for example, href, img src, background, input type, etc.), relative path URLs are converted into absolute path URLs.

The redirection marker 362 makes marks to the hyperlinks and form transmission parts in the HTML document collected from the HTTP server 400a of the target web service in order to redirect the hyperlinks and form transmission parts so that so that the redirection system 300 can retain the control right. By doing so, the document is redirected to the redirection agent 310 and transmitted to the user web browser such that even though the user clicks on the hyperlinks and form transmission, the control right is retained by the redirection system 300. Table 2 shows an example of redirection marking performed by the redirection marker 362.

The example of table 2 shows that the head part of each hyperlinked part is replaced by a CGI program of the redirection agent and the original URL is made to be transmitted in the form of a parameter. In addition, it is shown that the action part for each form transmission is also replaced by the form transmission CGI program of the redirection agent and the original action URL is added to a form input tag together with service ID registered in the profile information of the target web service.

TABLE 2

| Original HTML Doc | Marked HTML Doc |
|---|---|
| <a class=“Header-Menu-Links” | <a class=“Header-Menu-Links” |
| href=“http://ejournals.ebsco.com/my_SignMeUp.as | href=“redirect.cgi? ejgs s id=1001& linkUR |
| p”>Sign me up</a> | L=http://ejournals.ebsco.com/my_SignMeUp.asp” |
| | >Sign me up</a> |
| <Frameshift Rows=“72, *” border=“0”> | <Frameset Rows=“72, *” border=“0”> |
| <Frame name=“TOP” | <Frame name=“TOP” |
| SRC=“http://203.250.229.136/ihsstd.dll?Page&TOP | SRC=“redirect.cgi? ejgs s id=1002& linkUR |
| _PAGE&{6D3B8504-54C1-42E2-92D2- | L=http://203.250.229.136/ihsstd.dll?Page&TOP_PA |
| 5C50C3D34228}” noresize scrolling=no border=0> | GE&{6D3B8504-54C1-42E2-92D2-5C50C3D34228}” |
| <Frame name=“MAIN” | noresize scrolling=no border=0> |
| SRC=“http://203.250.229.136/ihsstd.dll?SearchPag | <Frame name=“Main” |
| e&SPECS_SEARCH&{6D3B8504-54C1-42E2-92D2- | SRC=“redirect.cgi? ejgs s id=1002& linkUR |
| 5C50C3D34228}” noresize border=0> | L=http://203.250.229.136/ihsstd.dll?SearchPage&S |
| </Frameshift> | PECS_SEARCH&{6D3B8504-54C1-42E2-92D2- |
| | 5C50C3D34228}” noresize border=0> |
| | </Frameset> |
| <FORM action=” | <FORM action=“submitform.cgi” |
| http://ejournals.ebsco.com/searchWaitingP | method=“post”> |
| age.asp” method=“post”> | <input type=text name=“txtSearchFor_Article” |
| <input type=text name=“txtSearchFor_Article” | size=“25” value=> |
| size=“25” value=> | <input type=“radio” name=“rdoWithIn_Article” |
| <input type=“radio” name=“rdoWithIn_Article” | Value=“TITLE” id=“Title”> |
| Value=“TITLE” id=“Title”> | <input type=“radio” name=“rdoWithIn_Article” |
| <input type=“radio” name=“rdoWithIn_Article” | Value=“ABSTRACT” Checked id=“TandA”> |
| Value=“ABSTRACT” Checked id=“TandA”> | <input type=“radio” name=“rdoWithIn_Article” |
| <input type=“radio” name=“rdoWithIn_Article” | Value=“FULLTEXT” id=“TAandFT”> |
| Value=“FULLTEXT” id=“TAandFT”> | <input type=text name=“txtAuthors_Article” |
| <input type=text name=“txtAuthors_Article” | size=“25” value=”> |
| size=“25” value=”> | <input type=“button” name=“ClearFindArticles” |
| <input type=“button” name=“ClearFindArticles” | class=“Buttons” value=“Clear” onclick=“javascript: |
| class=“Buttons” value=“Clear” onclick=“javascript: | txtAuthors_Article.value=“; |
| txtAuthors_Article.value=“; | txtSearchFor_Article.value=””> |
| txtSearchFor_Article.value=””> | <input type=“Submit” name=“FindArticles” |
| <input type=“Submit” name=“FindArticles” | class=“Buttons” value=“Find Articles” |
| class=“Buttons” value=“Find Articles”> | <INPUT TYPE=HIDDEN NAME=“_ejgs_s_id” |
| </FORM> | VALUE=“1001”> |
| | <INPUT TYPE=HIDDEN NAME=“_actionURL” |
| | VALUE=“http://ejournals.ebsco.com/search |
| | WaitingPage.asp”> |
| | </FORM> |

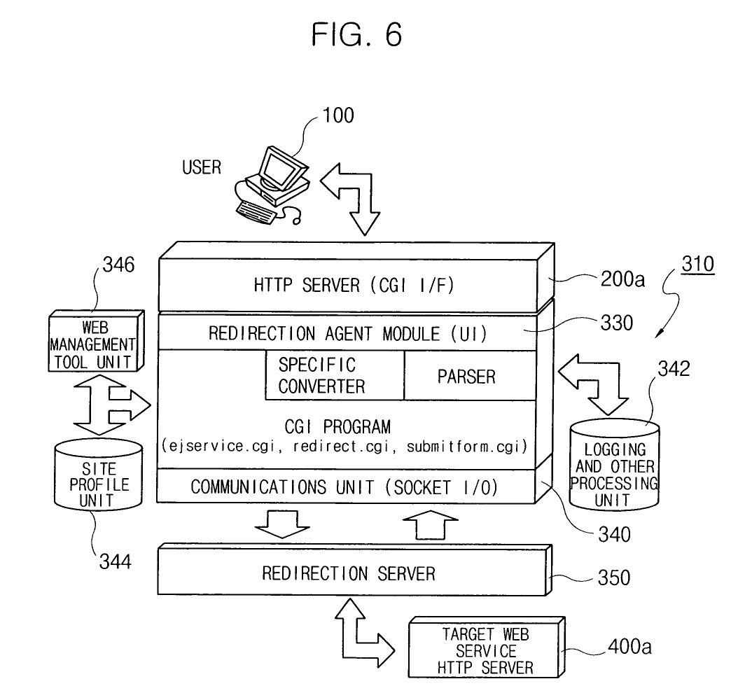

FIG. 6 is a diagram of the structure of a redirection agent unit (UI) 300. The redirection agent unit 300 comprises a redirection agent 330, which is formed with a specific converter, a parser, and a common gate interface (CGI), and a communications unit (socket I/O) 340 controlling data communications, as shown in FIG. 6. In addition, the redirection agent unit 330 further comprises a logging and other processing unit 342, a site profile management 344, and a web management tool 346.

The redirection agent 330 operates in the form of a CGI program of the web server. If the user executes the redirection agent 33 through the web server, the redirection agent 330 accesses the HTTP server 400a of the target web service requested by the user. At this time, the redirection agent 330 performs predetermined internal processing with the user not aware of it. The internal processing is to make a request again for the web document (URL), which is requested by the user, to the redirection server 350. If the redirection server 350 sends a result to the request, the redirection agent 330 receives the contents, performs additional conversion based on the contents registered in the target site profile, reconstructs the HTML document for differentiated service, and transmits the final document to the web browser of the user.

The function of each module of the redirection agent unit 310 will now be explained in detail.

First, the web management tool 346 registers and manages target web services to be offered as differentiated services through the redirection system. Information on the registered target sites are recorded in a database management system (DBMS) and the web management tool 346 performs functions for registration, modification and deletion of registration items, including URL information to access target web services, authentication information (when pay contents are provided), and when conversion is needed to provide differentiated services, parsing tags to distinguish a part to be converted in an HTML document, and document transformation parser information, and redirection conversion tags for exceptional events.

The parser is a program for implementing differentiated services in the original web document provided by a target web service. If a character string satisfying the condition of a parsing tag registered by the web management tool 346 is contained in the HTML document provided by the web service, the parser is called and the character string is replaced by the contents as described in the parser. Since this parser has an independent program function, the institution using the redirection system can implement additional applications services as desired without restrictions.

The specific converter performs conversion of exceptional HTML tags that are not standardized. The automatic document conversion module of the redirection server 350 performs automatic conversion only for standardized HTML tags. However, since service providers are modifying their web documents in their own way, web documents provided by countless web services are not necessarily using the standardized HTML tags. In this case the redirection system may lose the control right on the web document. To respond to this case, the specific converter performs conversion of exceptional tags, which are not standardized, by using redirection conversion tags for exceptional events registered in the web management tool so that the redirection system can retain the control right.

In the redirection agent 310 performing these functions, there are three core types of CGI programs. First, a program which provides redirection service performs user authentication and grants a session ID, and after the service is provided a second program performs redirection processing for all hyperlinks in an HTML document. Then, a third program performs redirection processing for all form transmissions in the HTML document. Each CGI program requests the document of the target web service to the redirection server 350 in a socket I/O method 340 when necessary, receives the result, if necessary, performs additional conversion, and then provides the document to the web browser of the user.

In addition to the B2B type web service providing digital contents for institutional customers described above, the present invention can be applied all web services irrespective of their types such that the control right is secured by using the redirection system of the present invention and a variety of application services can be provided.

In addition, a function for logging and managing information on use details of the digital contents by the user computer 100 and service bills, by monitoring communications between the redirection system 300 and the user computer 100, is embedded in the redirection system 300. This function can be fully implemented through securing the control right as described above. Furthermore, in order to limit the use frequency of a user and to protect copyrights of pay Internet contents from the user computer 100, a function such as limiting the use frequency, by which the use history of the user is traced and made not to exceed a predetermined frequency, can also be implemented in the redirection server 350.

Thus, it can be said that retainment of the control right over the web services being provided by other web servers is a very important invention, and it indicates that more actively differentiated application services can be provided shifting away from the current situation in which due to the characteristic of the HTTP type web service, the contents processed and provided by the contents provider's web server are passively received and used without change. Considering this, it can be said that the application range of the present invention is enormous.

According to the present invention described above, a variety of effects can be obtained as the following.

First, it can contribute to protection of copyrights through user control and service management. Pay Internet contents provided in an electronic library are provided in real time as useful information to lecturers and researchers irrespective of time and space. Compared to this, digital contents that can be obtained on the Internet by a user are endless. From the viewpoint of the information providers or contents providers providing this pay Internet contents, huge expenses are spent for controlling users based on contracts with copyright holders of the contents. This also causes a problem to libraries or institutions providing the pay Internet contents to users based on license contracts because the use limit of users is an essential condition to be added to their services. Actually, in some cases, a guidance indicating that downloading a large amount of pay Internet contents provided in the library is prohibited is written in the home page of the electronic library. The reason why this guidance is written on the home page to which a user accesses is to passively prevent illegal distribution of the pay Internet contents through downloading the Internet contents which is provided to the library according to a license contract with the contents provider.

To solve this problem, the present invention protects copyrights related to contents service through user control for all pay Internet contents provided by the electronic library. That is, by tracing all use processes of Internet contents services that a user accesses and by limiting the download frequency, the use of the original text, and the use frequency of predetermined functions, all use processes occurring in the electronic library can be controlled.

Secondly, with the redirection system according to the present invention, unified use statistics service can be received. The user statistics functions on pay Internet contents services provided by a variety of information providers have different platforms and statistic variables. Accordingly, the functions are not enough to accurately estimate the state of using Internet contents by users, when business directions and planning services are actually set in each institution. However, the redirection technology and user tracking function used in the present invention can accurately monitor and provide a variety of statistic data needed by each institution on the service use processes of a user, including accesses of the user, the types of retrieval queries, frequency of retrieval, the number of retrieved results, and frequencies of printing the retrieved results, download, viewing detailed information, and using the original text.

Thirdly, if the redirection technology of the present invention is used, it is possible to establish a customized pay Internet contents interface. In order to apply a unique interface provided in the pay Internet contents as is, the present invention converts relative paths of a variety of form tags, search CGIs, images, and icons, into absolute paths in real time, standardizes this rule, registers the rule in the redirection system so that the rule can be used in modifying the interface of the pay Internet contents without change. In addition, a specific page, including retrieval interface, retrieved result lists, and detailed record information, can be selected and interlocked with a variety of functions needed by the electronic library so that demands for specific texts, guidance, icons, link URLs, and URLs to link other information sources can be satisfied.

Fourthly, the redirection technology of the present invention enables linking to the electronic library system. When detailed information of pay Internet contents is viewed through the present invention, linking services provided by the electronic library, including the linking system service, original text copy service, library automation system connection, and linking service for a variety of academic information related to research activities such as reference index SCI information, can be provided. This works through parsing (data extraction and modification function) the detailed information page of the pay Internet contents.

Optimum embodiments have been explained above. However, it is apparent that variations and modifications by those skilled in the art can be effected within the spirit and scope of the present invention defined in the appended claims. Therefore, all variations and modifications equivalent to the appended claims are within the scope of the present invention.

What is claimed is:

1. A redirection technique based control method for Internet contents providing services in a system wherein a user computer receives digital contents, which are provided by a contents provider web server, through a web page provided by an intermediary web server through the Internet and a redirection system is disposed between the intermediary web server and the contents provider web server, said method performed by the redirection system comprising:
(a) instead the intermediary web server, transmitting a request from the user computer received through the web page, to the contents provider web server, and collecting a hyper-text markup language (HTML) document which the contents provider web server provides in response to the request;
(b) reconstructing the HTML document, by converting relative path uniform resource locators (URLs) of the contents such as a variety of form tags, search common gateway interfaces (CGIs), images, icons, etc. contained in the HTML document, into absolute path URLs and when necessary, further performing additional conversion; and
(c) converting all form tags and hyperlink tags in the HTML document so as to be marked with the redirection agent of the redirection system and transmitting a converted HTML document to the user computer,
wherein contents providing services are provided with the redirection system continuously retaining the control right on the web service of the contents provider web server for the user computer.

2. The control method of claim 1, wherein in the conversion of the hyperlink tags in the step (c), user authentication and session identification (ID) are given to the head part of each hyperlink tag, and if service is provided, a common gateway interface (CGI) program of the redirection agent, having a redirection processing function for all hyperlinks contained in an HTML document provided by the contents provider server, is added to the head part of each hyperlink tag, and original URLs are converted into a parameter form.

3. The control method of claim 1, wherein in the conversion of the form tags in the step (c), the form action part of each form tag is replaced by a form transmission CGI program of the redirection agent, having a redirection processing function for all form transmissions in the HTML document, and the original action URL is added to a form input tag together with service ID registered in the web service profile information of the contents provider web server.

4. The control method of claim 1, further comprising the step of performing management, registration, deletion, and modification of control rules, absolute path conversion rules, and limits on use frequency that are registered in order to secure a control right by using a redirection technique.

5. A redirection technique based control system for Internet contents providing services in a system wherein a user computer receives digital contents, which are provided by a contents provider web server, through a web page provided by an intermediary web server through the Internet, said control system, disposed between the intermediary web server and the contents provider web sever, comprising:
a redirection agent unit which operates in the form of a common gateway interface (CGI) program on the intermediary web server, communicates with a redirection server, requests again a document, which is requested by the user computer through the web page of the intermediary web server, to the contents provider server through the redirection server, receives a document of the contents provider server through the redirection server, performs additional conversion of the document, reconstructs the hyper-text markup language (HTML) document for differentiated services, and then transmits the final HTML document to the web browser of the user; and
the redirection server which is always in a waiting state in preparation for a call, and if the redirection agent unit makes a call and requests a document of a specific web service, in response to this, accesses a target contents providing web server and requests the document, receives contents provided by the target contents providing web server, performs conversion of the contents, and then transmits the contents to the redirection agent unit.

6. The control system of claim 5, wherein the redirection agent unit comprises a first program which provides first redirection service, a second program which gives user authentication and session ID, and if the service is provided, performs redirection processing for all hyperlinks contained in an HTML document provided by the contents provider server, and a third program which performs redirection processing for all form transmission in the HTML document, as the CGI programs.

7. The control system of claim 5, wherein the redirection agent unit further comprises: a web management tool which registers in a database and manages the web service of a target contents provider web server to be provided as differentiated services through the redirection system; and a specific converter which, based on redirection conversion tags on exceptional events registered in the web management tool, performs conversion for exceptional tags, which are not standardized and an automatic document conversion module is not able to process, so that control right is retained.

8. The control system of claim 7, wherein the redirection agent unit further comprises a parser unit which if an HTML document provided by the web service contains a character string satisfying the condition of a parsing tag registered through the web management tool, replaces the character string with the contents written in a parser in order to provide additional application services.

9. The control system of claim 7, wherein the registration item of the web management tool comprises at least one or a combination of items, including URL information to access target web services, authentication information when fee-charging contents are provided, and when conversion is needed to provide differentiated services, parsing tags to distinguish a part to be converted in an HTML document, and document transformation parser information, and redirection conversion tags for exceptional events.

10. The control system of claim 5, wherein the redirection server unit comprises at least: a virtual hypertext transfer protocol (HTTP) agent which accesses the target contents providing web server, requests a document in a GET or POST method, collects the document, and stores the collected document in a cache area for each user; an HTML converter which analyzes the contents of the HTML document which is collected and temporarily stored in the cache directory for each user by the virtual HTTP agent, and automatically converts all contents defined by relative URLs among tags such as ‘img’, ‘link’, ‘href’, etc. in the document, into absolute URLs; and a redirection marker which marks the redirection agent unit in the form tag and hyperlink parts so that the redirection system continuously retains the control right over all form tags and hyperlink tags in the HTML document temporarily stored before the document is transmitted to the user by the redirection agent, even though the user clicks on form transmission and hyperlinks.

11. The control system of claim 10, wherein the redirection marker performs conversion of the hyperlink tags by which user authentication and session identification (ID) are given to the head part of each hyperlink tag, and if service is provided, a common gateway interface (CGI) program of the redirection agent, having a redirection processing function for all hyperlinks contained in an HTML document provided by the contents provider server, is added, and original URLs are converted into a parameter form.

12. The control system of claim 10, wherein the redirection marker performs conversion of the form tags by which the form action part of each form tag is replaced by a form transmission CGI program of the redirection agent, having a redirection processing function for all form transmissions in the HTML document, and the original action URL is added to a form input tag together with service ID registered in the web service profile information of the contents provider web server.

13. The control system of claim 10, wherein the redirection server unit further comprises: a user session management which grants, maintains, and manages a session ID to a user using the redirection system; a cache area management which generates an independent cache directory for each user, and maintains and manages the directories till the user finishes the session of the redirection system; and a target web site session management which maintains and manages session information such as authentication information, cookie, etc. of the web service of the target contents providing web server accessed by the virtual HTTP agent and if there are continuous requests for documents, maintains the connection.

14. The control system of any one of claims 10 and 13, wherein the redirection server unit further comprises: a listener which is always waiting for a request from the redirection agent, and if there is a request, allocates a spare thread to handle the request; a request analyzer which analyzes the command and parameters requested by the redirection agent, determines the contents to be processed by the server, and calls related modules; and a virtual agent loader which in order to request web service to the web site of the target contents providing web server, writes a script for calling the virtual HTTP agent module and makes a call for the virtual HTTP agent.
